(19) United States
(12) Patent Application Publication
(10) Pub. No.: US 2025/0363036 A1
(43) Pub. Date: Nov. 27, 2025

(54) METHOD FOR IDENTIFYING AND REPAIRING SOURCE CODE DEFECTS

(71) Applicant: Beihang University, Beijing (CN)

(72) Inventors: Yongfeng YIN, Beijing (CN); Tianyi GUAN, Beijing (CN); Qingran SU, Beijing (CN); Haifeng LI, Beijing (CN)

(21) Appl. No.: 19/072,117

(22) Filed: Mar. 6, 2025

(30) Foreign Application Priority Data
May 22, 2024 (CN) 202410635001.7

(51) Int. Cl. G06F 11/362

(52) U.S. Cl. CPC G06F 11/3624

(57) ABSTRACT

Provided is a method for identifying and repairing source code defects, which relates to the technical field of software security. The method is implemented based on a source code input/output (I/O) module, a source code defect detection module, and a source code automated-repair module. The method includes: uploading a to-be-detected code file to the source code I/O module, and performing, by the source code defect detection module, deep analysis and defect detection on the source code; performing, by the source code automated-repair module through an abstract syntax tree (AST) template-driven automated repair method, automated repair on a code defect detected upstream. This application makes up for the lack of a method for automated detection and repair of code defects in the prior art, simplifies the work of code standardization during software development, and improves development efficiency.

### CROSS REFERENCE TO RELATED APPLICATION

This patent application claims the benefit and priority of Chinese Patent Application No. 2024106350017, filed with the China National Intellectual Property Administration on May 22, 2024, the disclosure of which is incorporated by reference herein in its entirety as part of the present application.

### TECHNICAL FIELD

The present disclosure relates to the technical field of software security, and in particular, to a method for identifying and repairing source code defects.

### BACKGROUND

In the era of rapid development of informatization, digitization, and intelligence nowadays, computer software plays an indispensable role in daily life and industrial production. Especially, as driven by the open source movement, software products are showing a trend of being large-sized, and the scale of code is also expanding rapidly. The quality of such software directly affects the operating efficiency and stability of related products and electronic devices. Rapidly improving the quality of software products has become an urgent need in the computer software industry in China. Automation of software code detection, testing, and maintenance is one of the key ways to ensure software quality and reliability.

Coding standards such as GJB8114 play a vital role in the aviation field. The coding standards provide a common and standardized programming guide for software development, ensure the readability and maintainability of the code, and play a key role in the successful execution of projects. By establishing a series of strict programming rules and standards, such coding standards not only ensure the functionality, efficiency, and security of the code, but also provide a solid foundation for the quality and security of software. In the prior art, although the coding standards such as GJB8114 are considered to be very important in related fields, there are still relatively few methods for automated detection of the defects mentioned in such standards, and the methods of automated repair are even more scarce. For modern software projects of a large scale and high complexity, this situation restricts the efficiency greatly during the development.

### SUMMARY

In view of the situation above, the present disclosure provides a method for identifying and repairing source code defects. The method is implemented based on a source code input/output (I/O) module, a source code defect detection module, and a source code automated-repair module to solve the problem that a lack of a method for automated detection and repair of code defects in the prior art reduces the development efficiency. The method includes the following steps:
uploading to-be-repaired source code to the source code I/O module, and performing static analysis configuration design on the source code;
performing, by the source code defect detection module, static analysis, semantic analysis, and style analysis on the source code to identify a potential defect in the source code, and outputting defect and error information of the source code; and
repairing, by the source code automated-repair module, the source code based on the defect and error information output by the source code defect detection module, where the source code automated-repair module implements repair of the source code through an abstract syntax tree (AST) template-driven automated repair method.

Further, the uploading to-be-repaired source code in a standard format to the source code I/O module includes:
importing the to-be-repaired source code into the source code I/O module, and creating a corresponding project environment; and
reading, by the source code I/O module, a file corresponding to the project environment, adding a corresponding source code directory, and performing relevant configuration on project properties to complete the uploading of the source code.

Further, the standard format in which the source code is uploaded includes a project file, a source code directory, and a single source code file.

Further, the method includes: uploading a static analysis configuration file to the source code I/O module to perform static analysis configuration design on the source code, where functions of the static analysis configuration file include: opening/closing an entire rule standard, opening/closing a rule subset, and opening/closing a specific rule.

Further, the AST template-driven automated repair method includes a manual template-based repair method and an assisted repair method. The assisted repair method is used as a supplement to the manual template-based repair method.

Further, the source code defect detection module includes a plurality of style checkers. The source code defect detection module performs style analysis on the source code based on the style checkers.

Further, the source code defect detection module categorizes the source code based on different file types of the source code, and assigns the source code to a corresponding style checker for style analysis based on the categorization result. The file types of the source code include a system header file, a header file, and a current file.

Further, the AST template-driven automated repair method allows a user to modify a tree structure of an AST.

Further, the AST template-driven automated repair method further includes a regular expression-based text pattern. The regular expression-based text pattern is used for matching and replacing a text pattern of the source code. The AST template is generated based on a clang tool.

Compared with the prior art, at least one of the above technical solutions adopted in some embodiments hereof include at least the following beneficial effects: The present disclosure can perform deep analysis and defect detection on the source code for a code file to be detected, and use an AST template-driven automated repair method to automatically repair a code defect detected upstream, thereby simplifying the work of code standardization during software development, and further improving development efficiency.

### BRIEF DESCRIPTION OF THE DRAWINGS

To describe the technical solutions in some embodiments of the present disclosure more clearly, the following outlines the drawings to be used in the embodiments. Evidently, the drawings outlined below are merely a part of embodiments of the present disclosure. A person of ordinary skill in the art may derive other drawings from the outlined drawings without making any creative efforts.

FIG. 1 is a schematic flowchart of a method according to an embodiment of the present disclosure;

FIG. 2 is a schematic diagram of a static analysis configuration file according to an embodiment of the present disclosure;

FIG. 3 is a schematic diagram of a style analysis module according to an embodiment of the present disclosure;

FIG. 4 is an overall schematic diagram of a source code automated-repair module according to an embodiment of the present disclosure;

FIG. 5 is a schematic diagram of to-be-repaired code according to an embodiment of the present disclosure;

FIG. 6 is a schematic diagram of a GJB8114R-1-2-5 repair algorithm according to an embodiment of the present disclosure; and

FIG. 7 is a schematic structural diagram of a platform according to an embodiment of the present disclosure.

### DETAILED DESCRIPTION OF THE EMBODIMENTS

The following describes some embodiments of the present disclosure in detail with reference to drawings.

The following describes the implementation of the present disclosure with reference to specific embodiments. A person skilled in the art can easily learn about other advantages and effects of the present disclosure from the content disclosed in this specification. Evidently, the described embodiments are merely a part of but not all of the embodiments of the present disclosure. The present disclosure may also be implemented or applied in other different manners. Based on different viewpoints and application requirements, details in this specification may be modified or changed without departing from the spirit of the present disclosure. It is hereby noted that to the extent that no conflict occurs, the following embodiments of the present disclosure and the features in the embodiments may be combined with each other. All other embodiments derived by a person of ordinary skill in the art based on the embodiments of the present disclosure without making any creative efforts still fall within the protection scope of the present disclosure.

The present disclosure provides a method for identifying and repairing source code defects. The present disclosure performs deep analysis and defect detection on the source code for a code file to be detected, and uses an AST template-driven automated repair method to automatically repair a code defect detected upstream, thereby simplifying the work of code standardization during software development, and further improving development efficiency.

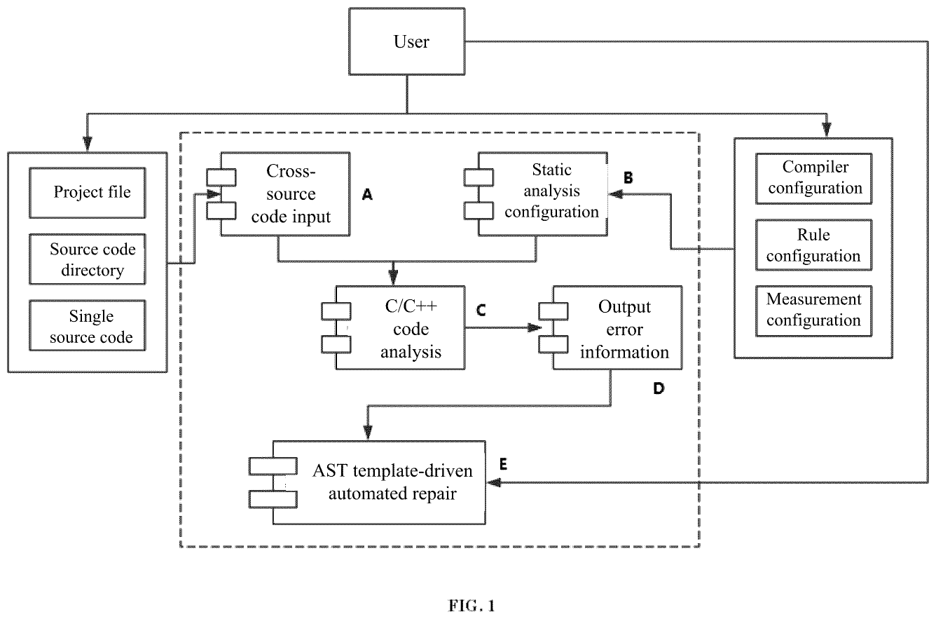

As shown in FIG. 1, in an embodiment of the present disclosure, the method for identifying and repairing source code defects is implemented based on a source code I/O module, a source code defect detection module, and a source code automated-repair module. The method specifically includes:

Step S100: Upload to-be-repaired source code to the source code I/O module, and perform static analysis configuration design on the source code.

Further, in step S100, the uploading to-be-repaired source code in a standard format to the source code I/O module includes the following steps:

Step S101: Import the to-be-repaired source code into the source code I/O module, and create a corresponding project environment. The source code upload format includes a project file, a source code directory, and a single source code file.

Step S102: The source code I/O module reads a file corresponding to the project environment, adds a corresponding source code directory, and performs relevant configuration on project properties to complete the uploading of the source code.

Specifically, in this embodiment, after the user uploads the to-be-repaired source code to the source code I/O module in a standard format (including a project file, a source code directory, and a single source code file), the corresponding project environment is created. Second, the source code file (*.sln, *.bpr, *.vcxproj) is input, the directories, files, and file structures contained in the project environment are automatically read in, the source code directory is added, and the corresponding source code file is automatically added. Finally, the properties of the project environment are configured. The platform supports mainstream compilers, allows the user to select a suitable compiler for compiling and analyzing the source code as required. The user needs to configure the header file that is relied on during detection. The file contains the interfaces required for compilation of the source code and the declarations. At the same time, the user also needs to specify a directory of the source code file and a library file. The library file may contain a third-party library or other code libraries that the project depends on.

Step S103: Upload a static analysis configuration file to the source code I/O module to perform static analysis configuration design on the source code, where functions of the static analysis configuration file include: opening/closing an entire rule standard, opening/closing a rule subset, and opening/closing a specific rule.

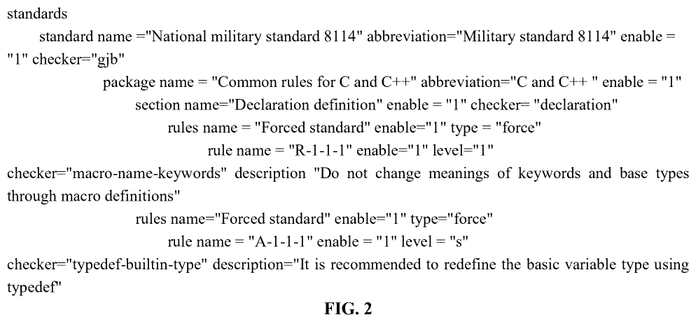

Specifically, after the relevant configuration of the project properties is partially completed in step S102, a static analysis configuration file is uploaded to the source code I/O module. This file defines the coding rules that need to be applied during the static analysis. The rules are typically used for checking for possible defects, style problems, or other programming practice problems in the source code. The static analysis configuration file can implement flexible rule configuration, including: turning on/off the entire rule standard, turning on/off a rule subset, and turning on/off a specific rule. The schematic diagram of a static analysis configuration file is shown in FIG. 2.

Further, the source code I/O module provides detailed information on each rule in the static analysis configuration file, including the serial number, name, and detailed description (instructions and precautions on the use of the rule, and other information) of the rule, examples of rule-violating code, and examples of correct code. In this way, the users can finely control the static analysis process, and ensure that the analysis results meet the specific requirements and expectations of the user.

Step S200: The source code defect detection module performs static analysis, semantic analysis, and style analysis on the source code to identify a potential defect in the source code, and outputs defect and error information of the source code.

Further, in step S200, the source code defect detection module includes a plurality of style checkers. The source code defect detection module performs style analysis on the source code based on the style checkers.

Further, in step S200, the source code defect detection module categorizes the source code based on different file types of the source code, and assigns the source code to a corresponding style checker for style analysis based on the categorization result. The file types of the source code include a system header file, a header file, and a current file.

Specifically, the source code defect detection module includes a static analysis module, a semantic analysis module, and a style analysis module. The static analysis technology performs an in-depth inspection on the code without executing the program. The static analysis module extracts key context information from the source code, and precisely identifies potential defects through in-depth correlation analysis.

Semantic analysis is a key component in compiler design, and deeply parses the source code based on a predetermined grammatical rule. This includes not only the identification of an identifier and inspection on a grammatical structure, but also a process of generating an abstract syntax tree (AST). The purpose of the semantic analysis process is to parse the given source code and generate a corresponding AST. The AST represents a hierarchical structure of the source code, and is essential for further analysis, optimization, and code generation.

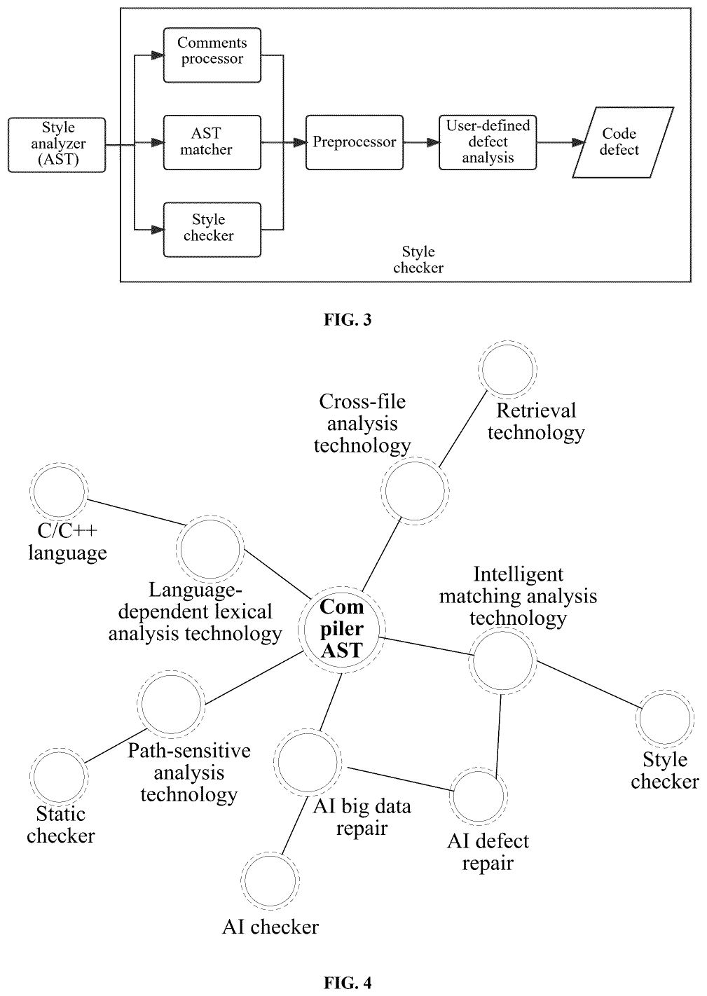

The code style and readability are critical to the long-term maintenance of software. As shown in FIG. 3, in the style analysis module, the present disclosure uses advanced algorithm technology to scan the AST tree and identify the parts that do not conform to the established programming specifications. The style analysis module includes a plurality of style checkers. The plurality of style checkers are designed to be as independent of each other as possible to facilitate subsequent system configuration and maintenance. In the entire inspection process, the source code files are finely categorized to exclude redundant analysis. The file types of source code files include:
(1) System header file: Although the amount of code of the system header file is very large, the system header file typically does not need to undergo conventional defect detection because the system header file has been rigorously optimized and tested;
(2) Header file: Substantially, the code in the header file are shared code, and therefore, so special care needs to be taken during annotation of the header file; and
(3) Current file: This is the main defect detection part. At this stage, the platform matches a predefined defect template based on an AST, so as to locate potential defects.

Through the above design, the style analysis module can effectively improve the efficiency and accuracy of code style analysis while reducing false positives and false negatives, thereby providing the user with more valuable feedback on the code quality.

Step S300: The source code automated-repair module repairs the source code based on the defect and error information output by the source code defect detection module. The source code automated-repair module implements repair of the source code through an AST template-driven automated repair method.

Further, the AST template-driven automated repair method includes a manual template-based repair method and an assisted repair method. The assisted repair method is used as a supplement to the manual template-based repair method.

Specifically, as shown in FIG. 4, the source code automated-repair module employs a variety of technologies, that is, a clang tool-based AST generation technology, an AST-based code defect precise-locating technology, a precise replacement technology, and a defect knowledge base-assisted recommended repair technology.

Among such technologies, the clang tool-based AST generation technology uses a front-end compiler of the clang to parse C/C++ code, and represents the code structure in a tree form. The generated AST helps to understand the code structure and syntax, and also performs hierarchical preprocessing for subsequent precise locating, and provides basic data for subsequent code analysis and processing.

The AST-based code defect precise-locating technology analyzes potential defects in the code by using the generated AST according to the defect pattern in the manual template. The AST can help determine specific structures and patterns in the code. This is very effective for locating common code errors and vulnerabilities. Precise locating of the code defects can greatly improve the accuracy and efficiency of automated repairs.

After the location of the code defect is located, the precise replacement technology uses an automated tool or script to precisely replace the defective code segment. In this process, it is ensured that the new code segment fixes the defect without introducing new problems, thereby reducing the workload and error risk of manual repair.

The defect knowledge base-assisted recommended repair technology refers to establishing a knowledge base containing known code defects and a repair method thereof. By analyzing the characteristics of the code defects, the system can recommend an appropriate repair method selected from the knowledge base, and assist developers in code repair. This technology is aimed at more complex defect patterns. As a supplement to the manual template-based repair method, this technology provides the user with a recommended repair method rather than directly repairing the defect when the template-based repair method is uncertain, thereby improving the repair success rate, minimizing the probability of rework, and truly achieving practicality.

Furthermore, the source code automated-repair module performs automated repair of source code as driven by an AST template. Specifically, the repair method includes two methods: a manual template-based repair method and an assisted repair method. The AST-based deep analysis on source code can precisely identify a specific grammatical structure and code segment, thereby ensuring the accuracy of defect location. Some algorithms of the manual template-based repair method are shown in Table 1. After the defective code is located accurately based on an AST template, the defective code is repaired by using a manual repair template designed for a plurality of rules. The assisted repair recommendation is a strategy for supplementing the manual template, and mainly provides recommendations for the defects that are not suitable for direct change and that are related to many rules. The manual template-based repair method considers the factor that the code data exhibits a higher structural complexity than ordinary text data. If the code data is merely regarded as serialized text information and is matched with a template, for example, if a regular expression is directly applied to the code data, a large number of misjudgments may occur. By contrast, the AST-based deep analysis on source code can precisely identify a specific grammatical structure and code segment, thereby ensuring the accuracy of defect location. In addition, the AST-based defect repair strategy allows the user to directly modify the tree structure, and avoids complex text replacement or rewriting operations, thereby ensuring the efficiency and quality of the repair. Moreover, the AST maintains the deep structural information of the code, and ensures that the repaired code remains semantically consistent.

TABLE 1
Some algorithms of the manual template-based repair method

| SN | RULE NUMBER | TO BE REPAIRED | REPAIR PLAN |
|---|---|---|---|
| 1 | R1-1-23 When the | TYPE funcname() | TYPE funcname(void) |
| | function parameter list is | | |
| | void, the void status | | |
| | must be specified by | | |
| | using a “void” field | | |
| 2 | R1-1-18 Array | (1) TYPE array [] = | (1) TYPE array [n] = {elem1, |
| | definitions without | {elem1,elem2, | elem2, ...elemn} |
| | explicit boundaries are | ...elemn} | //(TYPE∈int,char,short...) |
| | prohibited. | //(TYPE∈int,char,short...) | (2) TYPE array[12] = “hello |
| | | (2) TYPE array[] = “hello | world” |
| | | world” | |
| 3 | R-1-2-5 The operands in | (1) while(e1op_{bi}e2op_{compare}e3) | (1) whaile((e1op_{bi}e2) |
| | a logical discrimination | (2) if(e1op_{bi}e2op_{compare}e3) | op_{compare}e3) |
| | expression must be | (3) | (2) if((e1op_{bi}e2) op_{compare}e3) |
| | enclosed in parentheses | for(e1;e1op_{bi}e2op_{compare}e3;e1) | (3) |
| | | | for(e1;(e1op_{bi}e2op_{compare}e3);e1) |
| 4 | R1-2-1 The body of a | (1) while(e1op_{compare}e2) | (1) while(e1op_{compare}e2) |
| | loop must be enclosed in | e3=e1 | {e3=e1} |
| | curly braces | (2) for(e1; e1op_{compare}e2;e1) | (2) for(e1; e1op_{compare}e2;e1) |
| | | e3=e1 | {e3=e1} |
| 5 | R1-7-2 Inconsistent type | TYPE funcname(TYPE1 e1) | TYPE funcname(TYPE1 e1) |
| | between an actual | ... | ... |
| | parameter and a formal | TYPE2 e3; | TYPE2 e3; |
| | parameter of the | e2 = funcname(e3) | e2 = funcname(TYPE1 (e3)) |
| | function is prohibited. | // Legal conversion | // Legal conversion |
| 6 | R1-8-4 Use of octal | int e1 = 0123 | int e1 = 0123 // octal |
| | system must be | | |
| | explicitly commented | | |
| 7 | R1-10-3 A double | double e1 = 0.0; | double e1 = 0.0; |
| | variable must be | float e2 = e1; | float e2 = (float)e1; |
| | explicitly cast when | | |
| | assigned to a float | | |
| | variable | | |
| 8 | R1-3-2 The use of a | TYPE funcname(TYPE1 e1) | TYPE funcname(TYPE1 e1) |
| | function pointer must be | TYPE (*p)(TYPE1 e1)= | TYPE (*p)(TYPE1 e1)= |
| | explicitly stated with & | funcname | &funcname |
| 9 | R1-10-2 A long integer | long e1 = 0; | long e1 = 0; |
| | variable must be | short e2 = e1; | short e2 = (long)e1; |
| | explicitly cast when | | |
| | assigned to a short | | |
| | integer variable | | |
| 10 | R1-8-5 Numeric-type | TYPE e1 = 0.0f | TYPE e1 = 0.0F |
| | suffixes must use | | |
| | uppercase letters | | |

Further, the AST template-driven automated repair method further includes a regular expression-based text pattern. The regular expression-based text pattern is used for matching and replacing a text pattern of the source code. The AST template is generated based on a clang tool.

Specifically, the source code automated-repair module employs a comprehensive repair method that combines the AST and the regular expression. The AST is generated based on a clang tool, and the source code is repaired precisely by using the AST. On this basis, the source code automated-repair module pinpoints a specified code segment in the previous output of located defects, and determines the location that needs to be replaced or repaired. For more complex repair scenarios, the source code in the text pattern is matched and replaced by using regular expressions. By combining the precise structural analysis of the AST and the flexible text processing capabilities of the regular expressions, the platform aims to improve the efficiency and accuracy of automated repair and reduce false positives and false negatives.

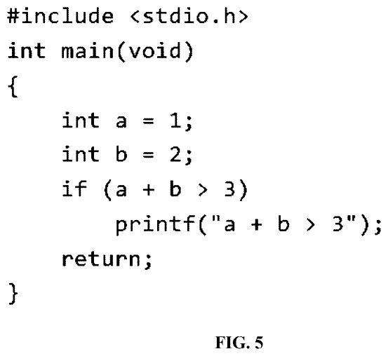

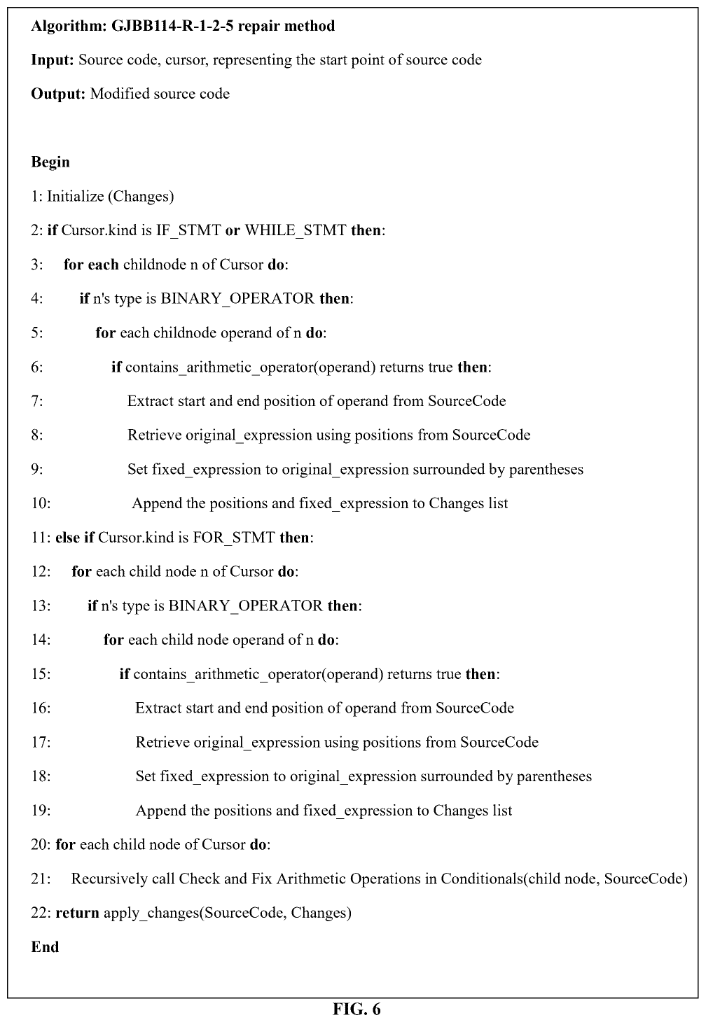

For example, FIG. 5 is a piece of code that violates GJB8114-1-2-5. Using regular expressions for direct matching when fixing the code will result in both the a+b in the printf( ) function and the a+b in the if condition being matched, thereby leading to false positives. In the technical solution hereof, the code is converted into an AST first. The location of condition can be pinpointed by using the AST. The repair algorithm for GJB8114R-1-2-5 is shown in FIG. 6.

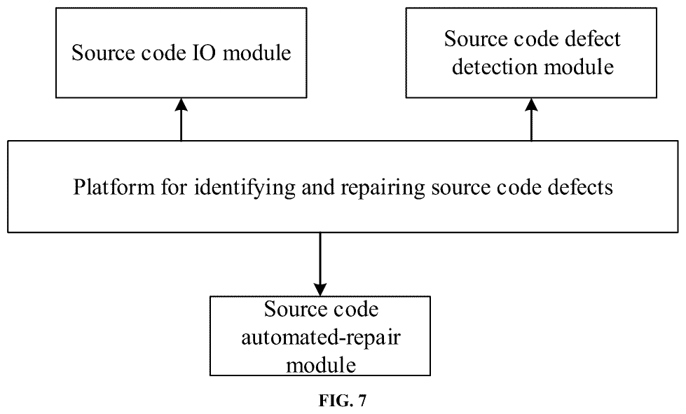

As shown in FIG. 7, a second embodiment of the present disclosure further provides a platform for identifying and repairing source code defects. The platform includes a source code I/O module, a source code defect detection module, and a source code automated-repair module.

The source code I/O module is configured to: record the configuration of the user into the platform after the user selects and uploads to-be-detected code and completes the configuration file, and read the structure of the code file; read the rule set that the user requires to check, and determine the file format of the final export report; and implement the front-end UI and interactive functions of the entire platform, and lower the user's usage threshold, and facilitate the user to use the platform to perform expected code improvement.

The source code defect detection module is configured to: perform the defect detection steps for the code when the user successfully uploads the code file and configures the content to be detected, including static analysis, semantic analysis, and style analysis; and find problems, record problem information, and finally output the information to the I/O module to facilitate being exported as a code detection report. This module focuses on the efficiency, recall rate, and accuracy of code detection, and implements defect detection methods for a variety of complex code structures to support the adaptivity to different coding habits of a plurality of developers.

The source code automated-repair module is configured to: provide an efficient development module for an upstream user to modify the code defect detection results; and, with the assistance of an intelligent repair tool provided by the platform, enable the user to implement one-click modification for simple defects and provide a reference for complex defects. This module focuses on the breadth of coverage of the modification template, reflects high accuracy in the automated repair support part, minimizes the probability of rework of the user, and needs to be of high reference significance for the method provided in the assisted repair recommendation part, so as to effectively assist the user in repairing defects.

To sum up, some embodiments of the present disclosure achieve at least the following technical effects:

The present disclosure provides higher development performance and efficiency, and implements cross-standard code defect identification and the AST template-driven automated repair method. The defect detection not only covers a variety of standards, but also customizes static analysis to make the detection results more compliant with user requirements. At the same time, the downstream defect automated-repair system is improved, and the defects detected by the upstream system are repaired automatically to reduce the workload of the user, thereby improving project development efficiency.

What is described above is merely exemplary embodiments of the present disclosure, but is not intended to limit the present disclosure. To a person skilled in the art, various modifications and variations may be made to embodiments of the present disclosure. Any and all modifications, equivalent replacements, improvements, and the like made without departing from the essence and principles of the present disclosure still fall within the protection scope of the present disclosure.

What is claimed is:

1. A method for identifying and repairing source code defects, wherein the method is implemented based on a source code input/output (I/O) module, a source code defect detection module, and a source code automated-repair module, and the method comprises:
uploading to-be-repaired source code to the source code I/O module, and performing static analysis configuration design on the source code;
performing, by the source code defect detection module, static analysis, semantic analysis, and style analysis on the uploaded source code to identify a potential defect in the source code, and outputting defect and error information of the source code; and
repairing, by the source code automated-repair module, the source code based on the defect and error information output by the source code defect detection module, wherein the source code automated-repair module implements repair of the source code through an abstract syntax tree (AST) template-driven automated repair method.

2. The method for identifying and repairing source code defects according to claim 1, wherein the uploading to-be-repaired source code to the source code I/O module comprises:
importing the to-be-repaired source code into the source code I/O module, and creating a corresponding project environment; and
reading, by the source code I/O module, a file corresponding to the project environment, adding a corresponding source code directory, and performing relevant configuration on project properties to complete the uploading of the source code.

3. The method for identifying and repairing source code defects according to claim 2, wherein a standard format in which the source code is uploaded comprises a project file, a source code directory, and a single source code file.

4. The method for identifying and repairing source code defects according to claim 2, wherein the performing static analysis configuration design on the source code comprises:
uploading a static analysis configuration file to the source code I/O module to perform static analysis configuration design on the source code, wherein functions of the static analysis configuration file comprise: opening/closing an entire rule standard, opening/closing a rule subset, and opening/closing a specific rule.

5. The method for identifying and repairing source code defects according to claim 1, wherein the AST template-driven automated repair method comprises a manual template-based repair method and an assisted repair method, and the assisted repair method is used as a supplement to the manual template-based repair method.

6. The method for identifying and repairing source code defects according to claim 1, wherein the source code defect detection module comprises a plurality of style checkers, and the source code defect detection module performs style analysis on the source code based on the style checkers.

7. The method for identifying and repairing source code defects according to claim 6, wherein the source code defect detection module categorizes the source code based on different file types of the source code, and assigns the source code to a corresponding style checker for style analysis based on the categorization result, and the file types of the source code comprise a system header file, a header file, and a current file.

8. The method for identifying and repairing source code defects according to claim 1, wherein the AST template-driven automated repair method allows a user to modify a tree structure of an AST.

9. The method for identifying and repairing source code defects according to claim 8, wherein the AST template-driven automated repair method further comprises a regular expression-based text pattern, and the regular expression-based text pattern is used for matching and replacing a text pattern of the source code, and the AST template is generated based on a clang tool.
